(19) United States
(12) Patent Application Publication
(10) Pub. No.: US 2021/0407500 A1
(43) Pub. Date: Dec. 30, 2021

(54) INTERACTIVE COMPANION LEARNING SYSTEM

(71) Applicant: Lamar Cox, Washington, DC (US)

(72) Inventor: Lamar Cox, Washington, DC (US)

(21) Appl. No.: 16/912,587

(22) Filed: Jun. 25, 2020

(51) Int. Cl. G10L 15/187; G10L 25/51; G06N 20/00; G06F 17/18

(52) U.S. Cl. CPC G10L 15/187; G06F 17/18; G06N 20/00; G10L 25/51

(57) ABSTRACT

An interactive artificial intelligence language learning system including an audio receiver, a data storage device comprising a database that stores a plurality of terminology in a first language and a corresponding plurality of terminology in a second language, and a processor that learns to generate a message to a term received by the audio receiver from a first user, the message based upon a statistical probability analysis comparing the received term with the stored plurality of terminology in the first language and the plurality of terminology in the second language.

### BACKGROUND OF THE INVENTION

### 1. Field of the Invention

The present general inventive concept relates to a learning system, and more particularly, to an immersion-based learning system that is configured to continuously interact with a user based on received information to assist the user in learning various disciplines, including language, sciences, computer language, mathematics and the like. The present general inventive concept also relates to an interactive companion learning system embodied as a portable digital/electronic companion device that communicates with the user throughout the day in order to simulate total immersion-based learning.

### 2. Description of Related Art

There are many learning tools and systems designed to help users learn various topics, including a new language. These conventional learning systems though varied in approach do not employ the concept of immersion learning. That is, these systems do not continuously interact with the user on an ongoing basis thus reinforcing new words and concepts presented to the user on going.

As such, these conventional systems require more time to effectively teach the user a new language.

Therefore, what is desired is an interactive companion learning system which significantly reduces the amount of time to learn a new discipline, such as a new language, by simulating total immersion in all aspects of the user's daily life.

### BRIEF SUMMARY OF THE INVENTION

Features and/or aspects of the present general inventive concept provide an interactive companion learning system which significantly reduces the amount of time to learn a new discipline, such as a new language, by simulating total immersion in all aspects of the user's daily life.

Features and/or aspects of the present general inventive concept also provide a portable interactive companion (IC) system and/or device that may function as an interactive teacher/tutor or personal assistant. The portable interactive companion (IC) system and/or device includes a portable electronic device, such as a mobile phone, tablet or the like and a main server which is in communication with the portable device via a wireless or wired connection. The main server may be in communication with an external artificial intelligence control system.

The foregoing and/or other aspects of the present general inventive concept may be achieved by providing an interactive artificial intelligence language learning system including an audio receiver, a data storage device comprising a database that stores a plurality of terminology in a first language and a corresponding plurality of terminology in a second language, and a processor that learns to generate a message to a term received by the audio receiver from a first user, the message based upon a statistical probability analysis comparing the received term with the stored plurality of terminology in the first language and the plurality of terminology in the second language.

The processor may generate a first message corresponding to a correct pronunciation, when the term received from the first user is statistically equivalent to a pronunciation of a corresponding term within the plurality of terminology in the second language stored in the database.

The processor may generate a second message corresponding to an incorrect pronunciation when the term received from the first user is statistically inequivalent to a pronunciation of a corresponding term within the plurality of terminology in the second language stored in the database.

The processor may generate a correct audible pronunciation of the term received from the first user in the second language from the plurality of terminology in the second language stored in the database.

The processor may store the term received by the audio receiver from the first user and the first response generated by the processor to evaluate a learning progress of the first user.

The processor may store predefined questions and user information of the first user in the database.

The user information may include geographical, demographical, and personal user information. However, the present general inventive concept is not limited thereto.

The processor may continuously generate messages using the predefined questions, the user information of the first user, and input received by the audio receiver from the first user to simulate immersion language learning.

The foregoing and/or other aspects of the present general inventive concept may also be achieved by providing a computer program product comprising a non-transitory computer readable storage device having a computer readable program stored thereon, wherein the computer readable program when executed on a computer causes the computer to receive audio inputs using an audio receiver, store a plurality of terminology in a first language and a corresponding plurality of terminology in a second language, and learn, with a processor, to generate a message based on a term received by the audio receiver from a first user, the message based upon a statistical probability analysis comparing the received term with the stored plurality of terminology in the first language and the plurality of terminology in the second language.

The computer may be further caused to generate, with the processor, a first message corresponding to a correct pronunciation, when the term received from the first user is statistically equivalent to a pronunciation of a corresponding term within the plurality of terminology in the second language stored in the database.

The computer may be further caused to generate, with the processor, a second message corresponding to an incorrect pronunciation when the term received from the first user is statistically inequivalent to a pronunciation of a corresponding term within the plurality of terminology in the second language stored in the database.

The computer may be further caused to generate, with the processor, a correct audible pronunciation of the term received from the first user in the second language from the plurality of terminology in the second language stored in the database.

The computer may be further caused to store, with the processor, the term received by the audio receiver from the first user and the first response generated by the processor to evaluate a learning progress of the first user.

The computer may be further caused to store, with the processor, predefined questions and user information of the first user in the database.

The user information may include geographical, demographical, and personal user information.

The computer may be further caused to continuously generate, with the processor, messages using the predefined questions, the user information of the first user, and input received by the audio receiver from the first user to simulate immersion language learning.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device.

It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 illustrates an interactive companion (IC) system according an example embodiment of the present general inventive concept.

FIG. 2 illustrates internal components within the interactive companion (IC) system illustrated in FIG. 1, according an example embodiment of the present general inventive concept.

FIG. 3 illustrates a process, using the interactive companion (IC) system illustrated in FIG. 1, to continuously interact with a user based on received information to assist the user in learning various disciplines.

### DESCRIPTION OF THE INVENTION

The present general inventive concept herein disclosed and described provides a portable interactive companion (IC) system and/or device that may function as an interactive teacher/tutor or personal assistant. The portable interactive companion (IC) system and/or device includes a portable electronic device, such as a mobile phone, tablet or the like and a main server which is in communication with the portable device via a wireless or wired connection. The main server may be in communication with an external artificial intelligence control system.

The IC system according to the present general inventive concept can facilitate and accelerate the learning process of various topics and disciplines, including the learning of a new language. The IC system allows a user to experience complete immersion in learning the new language by conversing and interacting with the user on a continuous basis. As a result, the IC system according to the present general inventive concept allows the user to learn the new language (or computer language) quickly by simulating complete immersion. As is well known and experienced by many people, the time to learn a new language can be drastically reduced by living within a community in which the language is spoken. The new language may be a foreign tongue or an area of technology, such as computer science or the like. However, for purposes of illustration, the portable IC system will be described in reference to learning a new language which is foreign to the user. However, the present general inventive concept is not limited thereto.

The portable IC system will provide the user with around the clock interaction, communication, and conversation. The user will be requested to listen and respond to questions, instructions, messages, and comments made by the IC system during the entire course of a day. For instance, the IC system would initially greet the user in the desired language and would wait for an appropriate response by the user to continue. The IC system can converse with the user based on the user's audible questions or comments, inputted interests, online information, personal user information and listening to information around the IC system, such as other users, radio, television, or the like.

A novel feature of the IC system according to the present general inventive concept is that the user may input detailed biographical user information and demographical data about him or herself. This data is accessed by an artificial intelligence system within the IC system to automatically and continuously generate questions, comments, and/or messages to initiate and continue conversations between the IC system and the user.

In addition, the IC system can also generate and audibly ask the user questions and provide answers to questions from the user based on the inputted user data or other information compiled from external sources, including the internet.

The IC system includes a database to store a plurality of words and terminology in a first language (e.g., English or origin language) and a corresponding plurality of words or terminology in a second language (e.g., Spanish or new language).

In example embodiments, the IC system may correct the user if the user's responses using the words in the second language are not pronounced correctly or are not the correct usage of words, for instance. For example, if the IC system asks the user “como estas” using the stored plurality of words or terminology in the second language, which corresponds to “how are you” in the first language. The user may respond with “bien gracias muy”, which corresponds to “good thank you very.” The IC system may analyze the users response and correct the users response by stating, in the second language “the correct response is “muy bien gracias.”

The IC system can also determine, using statistical analysis, the correctness of the user's pronunciation of words in the second language.

The IC system can also evaluate the progress of the user's learning by randomly asking questions to determine the user's proficiency with the new language (i.e., the second language). That is, the IC system would evaluate various aspects of the user's response, including pronunciation, correctness of word usage, tense, and the like. For example, the IC system may ask the user to say the numbers from 1 to 10 using the new language and would correct the user if the response was not in the correct order and/or pronunciation.

Further, the IC system may introduce new words and phrases from the new language to the user, translates the words and phrases, corrects the user's pronunciation and usage, as well as tracks the user's learning progress.

In other embodiments, the IC system may function as a personal assistant which can remind the user of appointments, items on a to-do list, important dates, and the like. The IC system may be configured to converse with the user based on information inputted by the user or obtained from the internet, such as current events, sporting news, and the like. However, the present general inventive concept is not limited thereto.

In the present embodiment, the IC system is composed of data cells and uses programs that access the data within the cells. The user would have user data cells that include a user biological cell, a user event cell (for things such as to-do list items and appointments), a user interest cell (for things such as food, movies, sports, hobbies, and the like), and a user commitment cell (for things such as work, study, exercise, group activities, and the like). However, the present general inventive concept is not limited thereto. That is, in alternative embodiments, the IC system may further include a user data cell that includes names of friends and family.

Further, the data cells may include a news and current event cell, a calendar cell (for things such as holidays, birthdays, anniversaries and the like) and a word and phrase cell that includes daily questions and greetings the IC system may say to the user in the new language. The IC system may further contain a calendar and clock.

The programs within the IC system may include a language translator, a questions and comments scheduler, and a user performance evaluator. The user can update any data cell with relevant information using the IC system at any time. In addition, the IC system expects the user to update relevant information within the user data cell for the IC system to have access to updated and correct information.

In further embodiments, the IC system may employ a GPS system that will allow it to know its relative location in order to ask questions relevant to the location and to respond to the user with situation and location relevant information.

In use, the IC system processes information when the user asks the IC system a question and the user responds to the IC system. In an embodiment of the present general inventive concept, the language translator module of the IC system receives the user's response. The IC system would then determine whether the user's response was appropriate or correct in the new language. If the IC system determines that the user's response was not appropriate, the IC system would respond by stating “did you mean to say . . . ” and then correcting the user's response. The IC system would then request the user to try again in order to reinforce the language training. However, if the IC system determines that the user's response was appropriate in the new language, the IC system would not provide any correction. The IC system may be used to record the exchange with the user learning the new language in order to evaluate the user's progress over time.

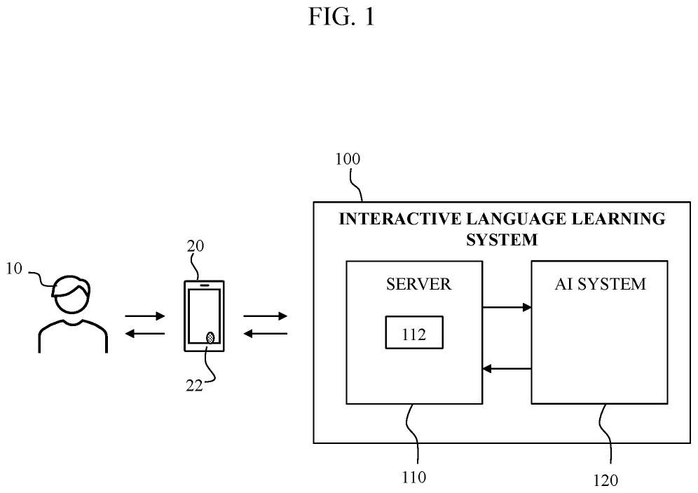

FIG. 1 illustrates an interactive companion (IC) system 100 according an example embodiment of the present general inventive concept.

Referring to FIG. 1, the IC system 100 is an artificial intelligence (AI) based system that acts as a real-time learning companion for a user 10 to learn various topics, including a foreign language, by simulating immersion.

In the present embodiment, the user 10 may interact audibly and/or visually with the IC system 100 using a communication device 20. The communication device 20 may be various types of computing devices, including a smartphone, tablet device, personal computer, laptop computer, or the like. The communication device 20 may connect to the IC system 100 through a wired or wireless connection through an Internet. However, the present general inventive concept is not limited thereto.

The user 10 may interact with the IC system 10 using a variety of communication, including voice, audio, video and/or text to send and/or receive messages.

In the present embodiment, the IC system 100 includes a server 110 coupled to an artificial intelligence system 120. The server 110 may include a processor 112 configured to route requests, questions, responses, and/or messages from the user 10 to the AI system 120. Similarly, the processor 112 is configured to route requests, questions and/or messages from the AI system 120 to the user 10 through the communication device 20. As such, although the IC system 100 may function as a language translator when the user requests translation of a term in a first language (e.g., English) into a second language (e.g. Spanish), the IC system 100 primarily functions as an interactive, artificial intelligence based language learning companion.

The IC system 100 functions as a real-time learning companion to simulate immersion within a desired topic, such as language, with the user 10, to teach the desired topic more efficiently and effectively. For instance, the IC system 100 converses with the user 10 throughout the day with questions and responses relevant to the user's 10 day.

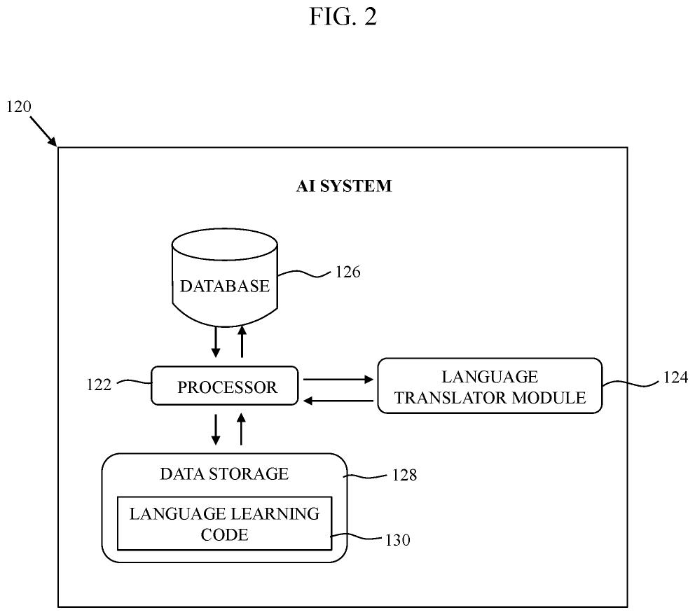

FIG. 2 illustrates internal components within the interactive companion (IC) system illustrated in FIG. 1, according an example embodiment of the present general inventive concept.

In the present embodiment, the present general inventive concept provides an interactive artificial intelligence language learning system 10 which includes an audio receiver 22 integrated within a communication device 20, a data storage device 126 comprising a database that stores a plurality of terminology in a first language and a corresponding plurality of terminology in a second language, and a processor 122 that learns to generate a message to a term received by the audio receiver from a first user.

The processor 122 generates the message based upon a statistical probability analysis comparing the received term from the user with the stored plurality of terminology in the first language and the plurality of terminology in the second language.

In alternative embodiments, the processor generates a first message corresponding to a correct pronunciation, when the term received from the first user is statistically equivalent to a pronunciation of a corresponding term within the plurality of terminology in the second language stored in the database.

In alternative embodiments, the processor generates a second message corresponding to an incorrect pronunciation when the term received from the first user is statistically inequivalent to a pronunciation of a corresponding term within the plurality of terminology in the second language stored in the database.

In alternative embodiments, the processor generates a correct audible pronunciation of the term received from the first user in the second language from the plurality of terminology in the second language stored in the database.

In alternative embodiments, the processor stores the term received by the audio receiver from the first user and the first response generated by the processor to evaluate a learning progress of the first user.

In the present embodiment, the database stores predefined questions and user information of the first user in the database, wherein the user information includes geographical, demographical, and personal user information. However, the present general inventive concept is not limited thereto.

In the present embodiment, the processor continuously generates messages using the predefined questions, the user information of the first user, and input received by the audio receiver from the first user to simulate immersion language learning.

In the present embodiment, the AI system 120 includes a processor 122 in communication with a language translator module 124, a database 126, and a data storage 128 including language learning code 130.

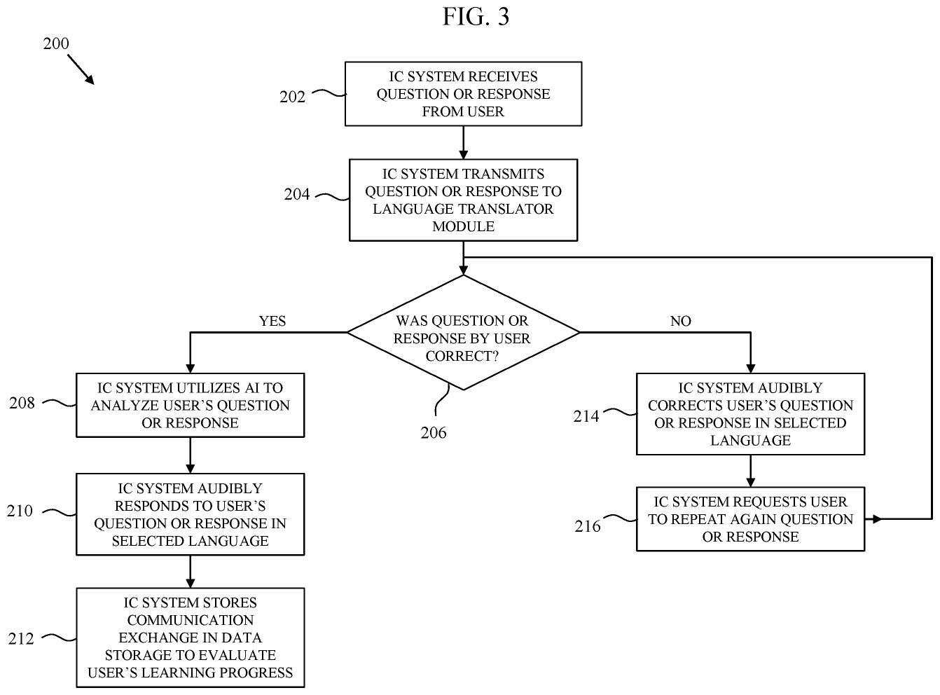

FIG. 3 illustrates a process 200 using the interactive companion (IC) system 100 illustrated in FIG. 1, to continuously interact with a user 10 based on received information to assist the user in learning various disciplines.

At process block 202, the process 200 receives a communication from the user 10 through a communication device 20. Then, at process block 204, the server 110 transmits this communication to an artificial intelligence system 120.

Next, at decision block 206, the process 200 determines whether the communication received from the user 10 was correct by using a language translator module 124 within the AI system 120 to conduct a statistical probability analysis comparing the received communication with terms, phrases, grammar stored within a database 126 (at process block 208).

Next, if the AI system 120 determines that the communication received from the user 10 is correct, the AI system 120 generates a message (visually and/or audibly) that is sent to the user 10 through the communication device 20 (at process block 210). This generated message is in direct response to the users 10 question, message, or response.

Next, the AI system 120 is designed and configured to store the communication received from the user 10 and the message generated by the AI system 120 within the database 126 to evaluate a progress of the user's 10 learning.

However, if the process 200 determines that the communication received from the user 10 is not correct, either grammatically or pronunciation of the word or phrase in the new language (at process step 214), the IC system 100 will audibly and/or visually correct the user's communication in the new language.

Next, at process block 216, the process 200 may request the user 10 to repeat the communication similar to the corrected version generated and played by the AI system 120 to ensure the user 10 has learned the correct term or phrase in the new language.

In the present embodiment, the present general inventive concept provides an interactive artificial intelligence language learning (IC) system guides users to enter data about himself that the IC system can draw upon to initiate conversations with the user. That is, users enter detailed biographical and demographical data about themselves that will provide the information available to the IC system for conversation. The more data provided by the user, the richer the conversations may be.

In alternative embodiments, the IC system translates words from a first language into words in a second language upon request, and corrects the user's pronunciation, grammar, and use of the new language.

For instance, the IC system may be designed to ask and answer questions made audible by the user. In addition, to further enrich conversation between user and the IC system, the IC system contains a clock, calendar and GPS.

Time, date and location always provide useful information for engaging the user during conversation in the second language.

The IC system, in alternative embodiments, for example, could ask where the user is going and for what purpose. Or the IC system may query the user about time spent asleep, what user had to eat for dinner, a trip planned, favorite movie, or the like. However, the present general inventive concept is not limited thereto.

In addition to being an immersion language companion, the IC system according to the present general inventive concept contains a complete language course of study, enhancing the immersion experience. As such, the IC system is particularly suited for the study of foreign languages, however, it can be employed in the study of any subject.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. An interactive artificial intelligence language learning system comprising:
an audio receiver;
a data storage device comprising a database that stores a plurality of terminology in a first language and a corresponding plurality of terminology in a second language; and
a processor that learns to generate a message to a term received by the audio receiver from a first user, the message based upon a statistical probability analysis comparing the received term with the stored plurality of terminology in the first language and the plurality of terminology in the second language.

2. The interactive artificial intelligence language learning system of claim 1, wherein the processor generates a first message corresponding to a correct pronunciation, when the term received from the first user is statistically equivalent to a pronunciation of a corresponding term within the plurality of terminology in the second language stored in the database.

3. The interactive artificial intelligence language learning system of claim 2, wherein the processor generates a second message corresponding to an incorrect pronunciation when the term received from the first user is statistically inequivalent to a pronunciation of a corresponding term within the plurality of terminology in the second language stored in the database.

4. The interactive artificial intelligence language learning system of claim 3, wherein the processor generates a correct audible pronunciation of the term received from the first user in the second language from the plurality of terminology in the second language stored in the database.

5. The interactive artificial intelligence language learning system of claim 3, wherein the processor stores the term received by the audio receiver from the first user and the first response generated by the processor to evaluate a learning progress of the first user.

6. The interactive artificial intelligence language learning system of claim 1, wherein the database stores predefined questions and user information of the first user in the database.

7. The interactive artificial intelligence language learning system of claim 6, wherein the user information includes geographical, demographical, and personal user information.

8. The interactive artificial intelligence language learning system of claim 7, wherein the processor continuously generates messages using the predefined questions, the user information of the first user, and input received by the audio receiver from the first user to simulate immersion language learning.

9. A computer program product comprising a non-transitory computer readable storage device having a computer readable program stored thereon, wherein the computer readable program when executed on a computer causes the computer to
receive audio inputs using an audio receiver;
store a plurality of terminology in a first language and a corresponding plurality of terminology in a second language; and
learn, with a processor, to generate a message based on a term received by the audio receiver from a first user, the message based upon a statistical probability analysis comparing the received term with the stored plurality of terminology in the first language and the plurality of terminology in the second language.

10. The computer program of claim 9, wherein the computer is further caused to generate, with the processor, a first message corresponding to a correct pronunciation, when the term received from the first user is statistically equivalent to a pronunciation of a corresponding term within the plurality of terminology in the second language stored in the database.

11. The computer program of claim 10, wherein the computer is further caused to generate, with the processor, a second message corresponding to an incorrect pronunciation when the term received from the first user is statistically inequivalent to a pronunciation of a corresponding term within the plurality of terminology in the second language stored in the database.

12. The computer program of claim 11, wherein the computer is further caused to generate, with the processor, a correct audible pronunciation of the term received from the first user in the second language from the plurality of terminology in the second language stored in the database.

13. The computer program of claim 11, wherein computer is further caused to store, with the processor, the term received by the audio receiver from the first user and the first response generated by the processor to evaluate a learning progress of the first user.

14. The computer program of claim 9, wherein the computer is further caused to store, with the processor, predefined questions and user information of the first user in the database.

15. The computer program of claim 14, wherein the user information includes geographical, demographical, and personal user information.

16. The computer program of claim 15, wherein the computer is further caused to continuously generate, with the processor, messages using the predefined questions, the user information of the first user, and input received by the audio receiver from the first user to simulate immersion language learning.
